(19) United States
(12) Patent Application Publication
(10) Pub. No.: US 2026/0295728 A1
(43) Pub. Date: Oct. 1, 2026

(54) LASER CUTTING NOZZLE

(71) Applicant: WuHan Raycus Fiber Laser Technologies CO., LTD, Wuhan, Hubei (CN)

(72) Inventors: Qi YANG, Wuhan, Hubei (CN); Faping WANG, Wuhan, Hubei (CN); Mingfeng LIU, Wuhan, Hubei (CN); Jianhong SHI, Wuhan, Hubei (CN); Dapeng YAN, Wuhan, Hubei (CN)

(73) Assignee: WuHan Raycus Fiber Laser Technologies CO., LTD, Wuhan, Hubei (CN)

(21) Appl. No.: 18/992,659

(22) PCT Filed: May 20, 2024
(86) PCT No.: PCT/CN2024/094247

§ 371 Date: Jan. 9, 2025

(30) Foreign Application Priority Data
Nov. 6, 2023 (CN) 202311463868.0

(51) Int. Cl. B23K 26/14; B23K 26/142; B23K 26/36; B23K 26/70

(52) U.S. Cl. CPC B23K 26/1462; B23K 26/142; B23K 26/36; B23K 26/702

(57) ABSTRACT

A laser cutting nozzle is disclosed in the present application, the laser cutting nozzle includes a first sleeve, a first housing, a nozzle, and a flow equalization block; a first light transmitting and gas blowing channel, and a first gas channel are formed in the first sleeve; the flow equalization block is arranged inside the first sleeve; a second light transmitting and gas blowing channel is arranged in the flow equalization block; the second light transmitting and gas blowing channel is in communication with the first light transmitting and gas blowing channel; multiple second gas channels are formed between the flow equalization block and the first sleeve; the first gas channel is in communication with the second gas channels, and the second gas channels are in communication with the second light transmitting and gas blowing channel.

The present application claims the priority to Chinese Patent Application No. 202311463868.0, filed to the China National Intellectual Property Administration on Nov. 6, 2023, the content of which is incorporated herein by reference in its entirety.

### TECHNICAL FIELD

The present application belongs to the field of laser processing technology, in particular to a laser cutting nozzle.

### BACKGROUND

A laser cutting machine is a type of laser cutting machine in which a fiber laser generator is used as a light source. A fiber laser machine is a new type of laser machine capable of outputting a high-energy-density laser beam. The laser beam output from the fiber laser machine can be focused on a surface of a workpiece, so that an area of the workpiece illuminated by an ultrafine focal spot is instantly melted and vaporized. The position illuminated by the spot is moved through a numerically controlled mechanical system, so that automatic cutting is achieved. A fiber laser cutting machine can be used for both flat cutting and bevel cutting, and edges of cutting seams are regular and smooth, widely applicable to products requiring high-precision cutting, such as metal plates.

A cutting head is a crucial component of the fiber laser cutting machine. During laser cutting, the cutting head is connected to the laser machine, and the laser beam is emitted from the laser cutting nozzle and irradiated onto a product to be cut, so that a slag is formed on the product to be cut. The slag is then blown away by pressurized gas to form a cutting seam. In existing technology, a light transmitting channel and a gas transporting channel are configured as one single channel, and gas is directly ejected from the nozzle. Due to uneven gas pressure, the cutting seam is irregular, resulting in poor cutting accuracy, which is unsuitable for high-precision instrument processing.

### SUMMARY

Embodiments of the present application provide a laser cutting nozzle to solve the problem of poor cutting accuracy caused by uneven gas pressure when pressurized gas is directly ejected from the nozzle in existing technology.

The embodiments of the present application provide a laser cutting nozzle, including:
a first sleeve, a first light transmitting and gas blowing channel being formed inside the first sleeve, and a first gas channel being formed on the first sleeve, the first gas channel extending along an axial direction of the first sleeve;
a first housing sleeved on the first sleeve;
a nozzle connected to the first housing, the first light transmitting and gas blowing channel being in communication with the nozzle; and
a flow equalization block arranged within the first sleeve, a second light transmitting and gas blowing channel being formed inside the flow equalization block, and the second light transmitting and gas blowing channel being in communication with the first light transmitting and gas blowing channel; multiple second gas channels being formed between the flow equalization block and the first sleeve, and the second gas channels extending along the axial direction of the first sleeve and being arranged at intervals along a circumferential direction of the flow equalization block; a gas inlet port of the first gas channel facing away from the nozzle, and gas outlet ports of the second gas channels facing away from the nozzle; the first gas channel being in communication with the second gas channels, and the second gas channels being in communication with the second light transmitting and gas blowing channel.

### Beneficial Effects

The beneficial effects of the present application are as follows. The laser cutting nozzle according to the embodiments of the present application include a first sleeve, a first housing, a nozzle, and a flow equalization block. A first gas channel is formed on the first sleeve, and second gas channels are formed between the flow equalization block and the first sleeve. A gas inlet port of the first gas channel faces away from the nozzle, and gas outlet ports of the second gas channels face away from the nozzle. Pressurized gas enters the second gas channels from the first gas channel and then enters the first light transmitting and gas blowing channel, and the second light transmitting and gas blowing channel, and is ejected from the nozzle. The pressurized gas is dispersed and diverted through the first gas channel and the second gas channels to achieve pressure equalization, so that the problem of poor cutting accuracy caused by uneven gas pressure when pressurized gas is directly ejected from the nozzle in existing technology is solved. The laser cutting nozzle according to the embodiments of the present application has advantages of simple structure, good pressure equalization effect, and high cutting accuracy.

### BRIEF DESCRIPTION OF THE DRAWINGS

To better illustrate technical solutions in the embodiments of the present application, the following provides a brief introduction to the drawings required for describing the embodiments. Obviously, the drawings described below are merely some embodiments of the present application, and for those skilled in the art, other drawings can be obtained based on these drawings without paying creative efforts.

For a more comprehensive understanding of the present application and its beneficial effects, the following description will be made with reference to the drawings. In the following description, identical reference numerals indicate identical components.

FIG. 1 is a perspective view of a laser cutting head according to the embodiments of the present application.

FIG. 2 is a side view of a first protection assembly according to the embodiments of the present application.

FIG. 3 is a cross-sectional view taken along line A-A in FIG. 2.

FIG. 4 is a schematic diagram of a structure of an aperture stop according to the embodiments of the present application.

FIG. 5 is another side view of the first protection assembly according to the embodiments of the present application.

FIG. 6 is an exploded view of the first protection assembly according to the embodiments of the present application.

FIG. 7 is a side view of an optical module according to the embodiments of the present application.

FIG. 8 is a cross-sectional view taken along line B-B in FIG. 7.

FIG. 9 is a perspective view of one form of a collimation assembly according to the embodiments of the present application.

FIG. 10 is a side view of FIG. 9.

FIG. 11 is a cross-sectional view taken along line C-C in FIG. 10.

FIG. 12 is a perspective view of another form of the collimation assembly according to the embodiments of the present application.

FIG. 13 is an exploded view of FIG. 12.

FIG. 14 is another side view of the optical module according to the embodiments of the present application.

FIG. 15 is a cross-sectional view taken along line D-D in FIG. 14.

FIG. 16 is a cross-sectional view taken along line E-E in FIG. 14.

FIG. 17 is a perspective view of a second protection assembly according to the embodiments of the present application.

FIG. 18 is a perspective cross-sectional view of the second protection assembly according to the embodiments of the present application.

FIG. 19 is a perspective view of a nozzle blowing assembly according to the embodiments of the present application.

FIG. 20 is a perspective cross-sectional view of the nozzle blowing assembly according to the embodiments of the present application.

FIG. 21 is an exploded view of the nozzle blowing assembly according to the embodiments of the present application.

FIG. 22 is a cross-sectional view of a first sleeve in the nozzle blowing assembly according to the embodiments of the present application.

### DESCRIPTION OF REFERENCE NUMERALS

100, fiber connector; 200, first protection assembly; 210, first mounting base; 220, first protection lens; 230, aperture stop; 231, first light transmitting channel; 232, light blocking surface; 233, fourth groove; 240, second heat dissipation channel; 241, second inlet port; 242, second outlet port; 250, first lens holder; 300, optical module; 310, collimation assembly; 311, collimation lens; 312, collimation lens holder; 3121, third heat dissipation channel; 3122, third inlet port; 3123, third outlet port; 313, sliding mechanism; 3131, guide rail; 3132, sliding block; 3133, limiting piece; 3134, limiting cooperation piece; 314, driving mechanism; 3141, voice coil motor; 3142, magnetic scale; 3143, sensing element; 315, fixing bracket; 3151, motor fixing plate; 3152, coil fixing plate; 320, focusing assembly; 330, second housing; 331, fourth heat dissipation channel; 3311, water inlet channel; 3312, water outlet channel; 3313, fourth inlet port; 400, second protection assembly; 410, lower mounting base; 411, first gas inlet port; 412, second gas inlet port; 413, second communication groove; 420, upper mounting base; 430, second protection lens; 440, second lens holder; 450, sealing member; 460, monitoring installation plate; 470, second adapter block; 480, fifth heat dissipation channel; 500, laser cutting nozzle; 510, first sleeve; 511, first light transmitting and gas blowing channel; 512, fin; 513, mounting hole; 514, third groove; 520, first housing; 521, cooling gas channel; 522, first inlet port; 523, first outlet port; 524, first gas outlet port; 526, cone; 527, ceramic ring; 528, adapter block; 529, connecting threaded sleeve; 530, first heat dissipation channel; 540, nozzle; 550, first gas channel; 560, flow equalization block; 561, second light transmitting and gas blowing channel; 562, second gas channel; 563, first groove; 564, second groove; 570, gas blowing cover plate; 571, first communication groove.

### DETAILED DESCRIPTION

The following description, accompanied by the drawings according to the embodiments of the present application, will clearly and comprehensively describe the technical solutions. Obviously, the described embodiments are merely a portion of the embodiments of the present application, rather than all of them. All other embodiments obtained by persons skilled in the art without creative efforts from the embodiments presented here, fall within the scope of protection of the present application.

The embodiments of the present application provide a laser cutting nozzle to solve the problem of poor cutting accuracy caused by uneven gas pressure when pressurized gas is directly ejected from the nozzle in existing technology.

The laser cutting nozzle can be applied to a laser cutting head, and the following will illustrate the application of the laser cutting nozzle to a laser cutting head with reference to the accompanying drawings.

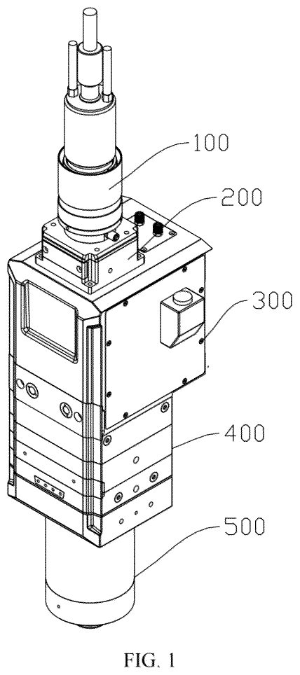

As shown in FIG. 1, a laser cutting head includes a fiber connector 100, a first protection assembly 200, an optical module 300, a second protection assembly 400, and a laser cutting nozzle 500 connected in sequence.

In the embodiments of the present application, the fiber connector 100 can be a QB connector, QBH connector, or QC connector, and is configured to connect to an output head of a fiber laser machine. The model of the fiber connector 100 is compatible with the output head of the fiber laser machine, so that a laser beam output from the fiber laser machine is guided into the laser cutting head.

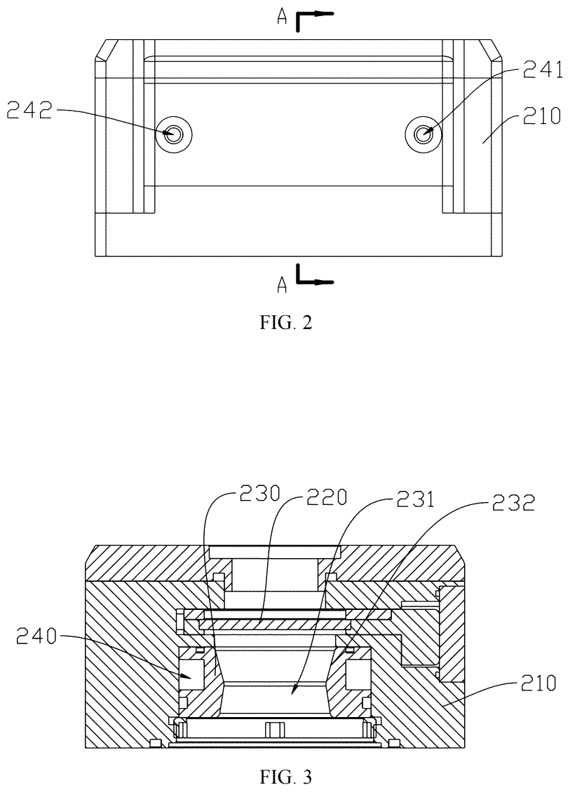

In the embodiments of the present application, as shown in FIG. 2 and FIG. 3, the first protection assembly 200 includes at least a first mounting base 210 and a first protection lens 220. The first protection lens 220 is detachably mounted on the first mounting base 210, so that the replacement of the first protection lens 220 is facilitated and dust is prevented from entering the optical module 300 from a side where the fiber connector 100 is arranged, thereby the optical module 300 is protected and the reliability of the optical module 300 is improved.

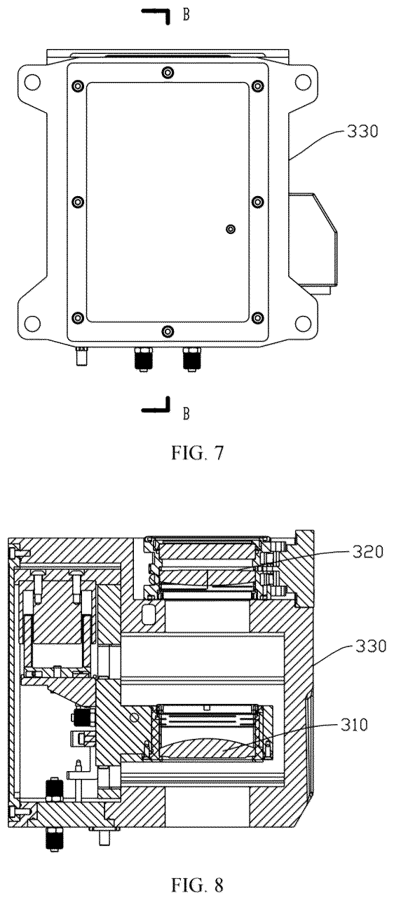

In the embodiments of the present application, as shown in FIG. 7 and FIG. 8, the optical module 300 includes at least a second housing 330, a collimation assembly 310, and a focusing assembly 320. Both the collimation assembly 310 and the focusing assembly 320 are installed within the second housing 330. Collimation lens of the collimation assembly 310 is coaxially arranged with focusing lens of the focusing assembly 320, and the collimation lens are arranged closer to the first protection assembly 200 than the focusing lens. The laser beam output from the fiber laser machine is first collimated by the collimation assembly 310, then focused by the focusing assembly 320, and emitted from the laser cutting nozzle 500 for laser cutting.

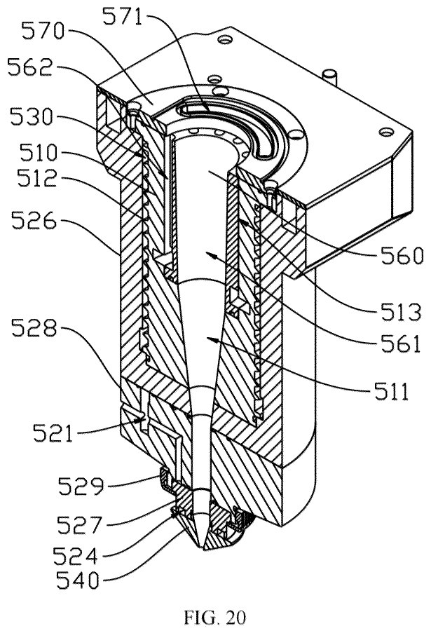

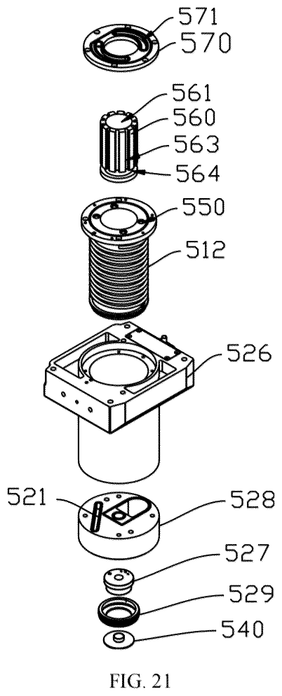

In the embodiments of the present application, as shown in FIG. 19, FIG. 20, and FIG. 21, the laser cutting nozzle 500 includes a first sleeve 510, a first housing 520, a nozzle 540, and a flow equalization block 560. A first light transmitting and gas blowing channel 511 is formed in the first sleeve 510. A first gas channel 550 extending along an axial direction of the first sleeve 510 is formed in the first sleeve 510. The first housing 520 is sleeved on the first sleeve 510. The nozzle 540 is connected to the first housing 520. The first light transmitting and gas blowing channel 511 is in communication with the nozzle 540. A mounting hole 513 and the first light transmitting and gas blowing channel 511 are arranged inside the first sleeve 510. The mounting hole 513 is adapted to the flow equalization block 560 and is arranged above the first light transmitting and gas blowing channel 511. The flow equalization block 560 is installed within the first sleeve 510, and a second light transmitting and gas blowing channel 561 is formed inside the flow equalization block 560. The first light transmitting and gas blowing channel 511 is in communication with the second light transmitting and gas blowing channel 561. Both the first light transmitting and gas blowing channel 511, as well as the second light transmitting and gas blowing channel 561 are coaxially arranged with the first sleeve 510, and the second light transmitting and gas blowing channel 561 is arranged above the first light transmitting and gas blowing channel 511.Multiple second gas channels 562 are formed between an outer wall of the flow equalization block 560 and an inner wall of the first sleeve 510. The multiple second gas channels 562 are arranged at intervals along a circumferential direction of the flow equalization block 560, and the second gas channels 562 extend along the axial direction of the first sleeve 510. At least one first gas channel 550 is formed in the first sleeve 510 and extends along the axial direction of the first sleeve 510. A gas inlet port of the first gas channel 550 faces towards the second protection assembly 400, while gas outlet ports of the second gas channels 562 face towards the second protection assembly 400. An end, facing away from the second protection assembly 400, of the first gas channel 550 is in communication with ends, facing away from the second protection assembly 400, of the second gas channels 562. The second gas channels 562 are in communication with the second light transmitting and gas blowing channel 561, and the second light transmitting and gas blowing channel 561 is in communication with the first light transmitting and gas blowing channel 511.

It is understandable that the first gas channel 550 is in communication with an external gas source. Along a radial direction of the first sleeve 510, the first gas channel 550 is arranged outside the second gas channels 562, and the second gas channels 562 are arranged outside the second light transmitting and gas blowing channel 561. The gas enters the second gas channels 562 from the first gas channel 550, then enters the second light transmitting and gas blowing channel 561, and enters the nozzle 540 from the first light transmitting and gas blowing channel 511. The gas is diverted multiple times, and compared to directly entering the first light transmitting and gas blowing channel 511 from the second light transmitting and gas blowing channel 561, the gas is distributed uniformly, which reduces gas pressure loss inside the second light transmitting and gas blowing channel 561, as well as the first light transmitting and gas blowing channel 511, and thereby gas pressure is ensured, gas blowing effect is improved, and the shape of the cutting seam is guaranteed.

In some embodiments, as shown in FIG. 19 and FIG. 20, a first heat dissipation channel 530 is formed between the first housing 520 and the first sleeve 510. The first heat dissipation channel 530 is connected to an external water-cooling machine. A circulating coolant, which can be water, oil, or a mixture of water and oil, is introduced into the first heat dissipation channel 530. A cooling gas channel 521, a first inlet port 522, a first outlet port 523, and a first gas outlet port 524 are formed on the first housing 520. The first inlet port 522 and the first outlet port 523 are in communication with the first heat dissipation channel 530. The first heat dissipation channel 530 is connected to the external water-cooling machine through the first inlet port 522 and the first outlet port 523. The cooling gas channel 521 is connected to an external cooling gas source. The first gas outlet port 524 is in communication with the cooling gas channel 521 and is arranged on a side close to the nozzle 540, allowing cold gas to directly act on the nozzle 540, so that heat from the nozzle 540 is dissipated through the cold gas. Heat from the laser cutting nozzle 500 is dissipated through the first heat dissipation channel 530, so that an excessively high temperature of the laser cutting nozzle 500 that could affect the surrounding optical module 300 is avoided. The nozzle 540 is connected to a side, facing away from the second protection assembly 400, of the first housing 520. The first light transmitting and gas blowing channel 511 is in communication with the nozzle 540, and the first gas outlet port 524 is arranged on a side, close to the nozzle 540, of the first housing 520.

It is understandable that according to the embodiments of the present application, the first protection assembly 200 and the second protection assembly 400 are arranged at a light input side and a light output side of the optical module 300 to block both sides of the optical module 300, so that dust is prevented from entering the optical module 300, the optical reliability of the collimation assembly 310 and the focusing assembly 320 of the optical module 300 is ensured, and the situation where the collimation assembly 310 and the focusing assembly 320 are burnt out due to dust accumulation and heat generated is avoided, thereby the service life of the optical lenses is extended. Furthermore, according to the embodiments of the present application, a first heat dissipation channel 530 is formed between the first sleeve 510 and the first housing 520 of the laser cutting nozzle 500, and the laser cutting nozzle 500 is cooled and heat from the laser cutting nozzle is dissipated through the first heat dissipation channel 530. A cooling gas channel 521 is further formed in the first housing 520 to cool the nozzle 540. In case that the first heat dissipation channel 530 is not formed, the temperature of the cooling gas in the cooling gas passage 521 would be high due to heat generated by the laser cutting nozzle 500, making it impossible to cool the nozzle 540 and dissipate heat from the nozzle, and the nozzle 540 is easily burnt out. Moreover, since the laser cutting nozzle 500 is adjacent to the optical module 300, in case that the temperature of the laser cutting nozzle 500 is high, the heat is transferred to the optical module 300, causing the temperature of the optical module 300 to be high as well, thus the collimation assembly 310 and the focusing assembly 320 may be burnt out, affecting the service life of the optical module 300. Therefore, according to the embodiments of the present application, the heat dissipation effect of the laser cutting head is improved, making it more suitable for high-power laser machines, enhancing the reliability of the laser cutting head, ensuring cutting efficiency, and making it applicable to precision instrument processing.

Based on the aforementioned embodiments, as shown in FIG. 20, multiple second gas channels 562 are arranged at equal intervals along the circumferential direction of the flow equalization block 560. The number of the second gas channels 562 is greater than the number of the first gas channel 550, so that the pressure equalization effect is enhanced. The more the second gas channels 562, the better the pressure equalization effect.

Based on the aforementioned embodiments, as shown in FIG. 21, multiple first grooves 563 and second grooves 564 are formed in an outer surface of the flow equalization block 560. The first grooves 563 extend along an axial direction of the flow equalization block 560, while the second grooves 564 are distributed along the circumferential direction of the flow equalization block 560. The second grooves 564 are arranged on a side, facing away from the second protection assembly 400, of the flow equalization block 560. The first grooves 563 are in communication with the second grooves 564. Both the first grooves 563 and the second grooves 564 are in a structure of a semi-circular groove. The flow equalization block 560 is hermetically connected to the first sleeve 510. The first grooves 563 and the second grooves 564 are blocked by the inner wall of the first sleeve 510 to form the second gas channels 562. The first gas channel 550 is in communication with the second grooves 564.

It is understandable that a gas flowing out of the first gas channel 550 is buffered by the second grooves 564 before entering the first grooves 563, reducing gas pressure loss, so that the pressure in each of the first grooves 563 is ensured to be the same, achieving good pressure equalization effect.

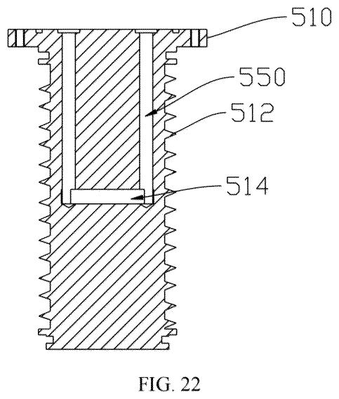

As shown in FIG. 22, a third groove 514 is formed in the inner wall of the first sleeve 510. The third groove 514 is arranged close to a side where the first light transmitting and gas blowing channel 511 is arranged. The third groove 514 is in communication with a gas outlet port of the first gas channel 550. The third groove 514 is arranged opposite to the second grooves 564. The third groove 514 and the second grooves 564 are enclosed to form a ring-shaped channel to reduce gas pressure loss.

In some embodiments, as shown in FIG. 20 and FIG. 21, the laser cutting nozzle 500 further includes a gas blowing cover plate 570. The gas blowing cover plate 570 is in a shape of a circular disk. The gas blowing cover plate 570 is arranged inside the first housing 520 and is connected to the first housing 520 via a pin. The gas blowing cover plate 570 is arranged on a side, close to the optical module 300, of the first sleeve 510 and is hermetically connected to the first sleeve 510 via a sealing ring. A first communication groove 571 is formed in a side, facing away from the flow equalization block 560, of the gas blowing cover plate 570. The first communication groove 571 is arc-shaped. The first communication groove 571 is in communication with gas inlet ports of multiple first gas channels 550. For example, the gas inlet ports of two first gas channels 550 share one first communication groove 571, or the gas inlet ports of four first gas channels 550 share one first communication groove 571. The gas inlet ends of the first gas channels 550 are converged through the gas blowing cover plate 570, so that gas is inlet through the first gas channels 550 simultaneously and pressure equalization effect is ensured.

In some embodiments, as shown in FIG. 20 and FIG. 22, fins 512 are spirally arranged on an outer surface of the first sleeve 510. The fins 512 are hermetically connected to the first housing 520. Grooves between adjacent fins 512 and the interior of the first housing 520 are enclosed to form the first heat dissipation channel 530. The spiral-shaped first heat dissipation channel 530 increases a length of the heat dissipation channel and improves heat dissipation effect.

In the aforementioned embodiments, two fins 512 are spirally arranged on the surface of the first sleeve 510, and the spiral directions of the two fins 512 are the same. Two spiral-shaped first heat dissipation channels 530 are formed between the first sleeve 510 and the first housing 520, which further increases the length of the heat dissipation channel and improves heat dissipation effect. Additionally, even if one of the first heat dissipation channels 530 is blocked, the other can still function, which ensures the reliability of heat dissipation.

In some embodiments, as shown in FIG. 20 and FIG. 21, the first housing 520 includes a cone 526 and a ceramic ring 527. The cone 526 is sleeved on the first sleeve 510, and the cone 526 is sealed to the first sleeve 510 to form the first heat dissipation channel 530. A flange connection part is arranged at a side, close to the second protection assembly 400, of the cone 526. The cone 526 is detachably connected to the second protection assembly 400 via a pin. A side, close to the nozzle 540, of the cone 526 is in a shape of a cylinder. The nozzle 540 is connected to the cone 526 through the ceramic ring 527, and a cooling gas channel 521 is arranged to penetrate through the cone 526 and the ceramic ring 527. A first gas outlet port 524 is arranged on a side, close to the nozzle 540, of the ceramic ring 527.

It is understandable that the cooling gas channel 521 blows cold gas directly towards the nozzle 540 through the ceramic ring 527, reducing the loss of cold gas and improving the cooling and heat dissipation effect of the nozzle 540.

Based on the aforementioned embodiments, as shown in FIG. 19, the first housing 520 further includes a first adapter block 528 arranged between the cone 526 and the ceramic ring 527. The cone 526 is connected to the ceramic ring 527 through the first adapter block 528, and the ceramic ring 527 is connected to the first adapter block 528 via a connecting threaded sleeve 529. The cooling gas channel 521 is arranged to penetrate through the cone 526, the adapter block 528, and the ceramic ring 527. The first housing 520 is assembled from separated structures, which is easy to install, disassemble, and maintenance.

The cooling gas channel 521 includes a first sub-segment, a second sub-segment, a third sub-segment, and a fourth sub-segment. The first sub-segment extends along an axis of the cone 526. The second sub-segment is arranged on a side, facing towards the cone 526, of the first adapter block 528, and is in a shape of a long groove. One end of the second sub-segment is connected to the first sub-segment, and the other end is connected to the third sub-segment. The third sub-segment is arranged inside the first adapter block 528, and is bent. The fourth sub-segment is arranged inside the ceramic ring 527. A first gas outlet port 524, which is of an annular groove structure, is arranged at a side, facing towards the nozzle 540, of the ceramic ring 527. Gas is blown into the nozzle through the annular first gas outlet port 524, so that a large blowing area is achieved, which is beneficial for heat dissipation of the nozzle 540.

In some embodiments, as shown in FIG. 3, the first protection assembly 200 includes a first mounting base 210, a first protection lens 220, and an aperture stop 230. The first mounting base 210 is connected to the fiber connector 100, and the first protection lens 220 and the aperture stop 230 are installed inside the first mounting base 210. The first protection lens 220 is closer to the fiber connector 100 than the aperture stop 230.

In the embodiments of the present application, the first protection lens 220 is used for dust prevention to prevent dust from entering the optical module 300 behind. The aperture stop 230 is arranged inside the first mounting base 210 to block light. The first protection lens 220 and the aperture stop 230 are integrated into the first protection assembly 200 through the first mounting base 210, facilitating the overall installation and disassembly of the first protection assembly 200 and improving the maintainability of the module.

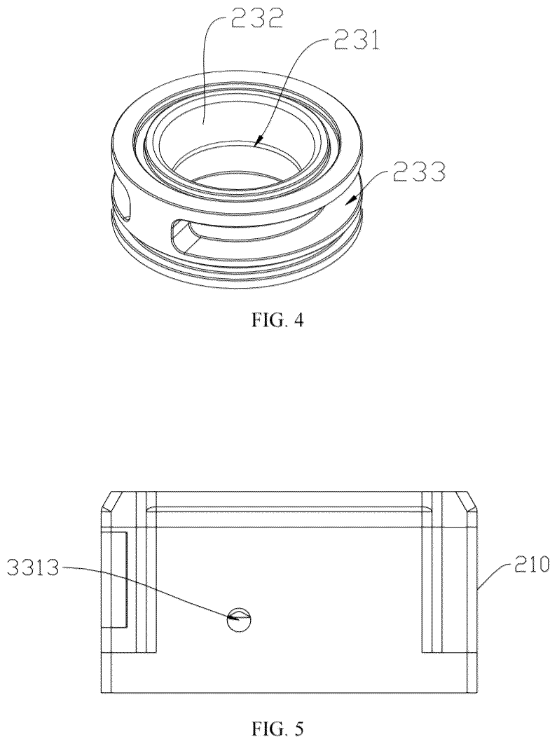

In some embodiments, as shown in FIG. 3, FIG. 4, and FIG. 6, the aperture stop 230 is in a shape of a cylinder and includes a first light transmitting channel 231. A light blocking surface 232 is formed on an inner wall of the first light transmitting channel 231. The light blocking surface 232 is arranged close to the first protection lens 220 and is in a shape of a horn. A diameter of one end, close to the first protection lens 220, of the light blocking surface 232 is larger than a diameter of the other end, so that light is blocked through the light blocking surface 232, providing a large light blocking area.

In some embodiments, the light-blocking surface 232 is coated with a black high-temperature resistant coating that can withstand temperatures up to 1400° C., so that the high-temperature resistance of the aperture stop 230 is improved.

In some embodiments, the black high-temperature resistant coating is deburred to increase a laser absorption rate of the light blocking surface 232, reduce laser reflection, prevent scattered light caused by laser reflection, and make the performance of the aperture stop 230 stable.

In some embodiments, as shown in FIG. 2, FIG. 3, and FIG. 4, an outer surface of the aperture stop 230 is hermetically connected to an inner surface of the first mounting base 210. A second heat dissipation channel 240 is formed between the aperture stop 230 and the first mounting base 210. A second inlet port 241 and a second outlet port 242 are formed in the first mounting base 210, and both the second inlet port 241 and the second outlet port 242 are in communication with the second heat dissipation channel 240.

The second heat dissipation channel 240 dissipates heat from the aperture stop 230, so that physical damage to the aperture stop 230 caused by excessively high temperature of the aperture stop 230 is avoided, and also heat transfer to the optical module 300 below is avoided, protecting the optical module 300 and improving the reliability of the laser cutting head.

Based on the aforementioned embodiments, as shown in FIG. 4, a fourth groove 233 is formed on the outer surface of the aperture stop 230. The aperture stop 230 is hermetically connected to the first mounting base 210. An inner wall of the first mounting base 210 and the fourth groove 233 are enclosed to form the second heat dissipation channel 240. The fourth groove 233 is in a shape of a non-closed ring. The second inlet port 241 is arranged at one end of the fourth groove 233 and the second outlet port 242 is arranged at the other end of the fourth groove 233, maximizing an area of the second heat dissipation channel 240 and improving heat dissipation effect.

Based on the aforementioned embodiments, as shown in FIG. 6, the first protection assembly 200 further includes a first lens holder 250. The first protection lens 220 is mounted on the first lens holder 250. The first lens holder 250 is drawer-mounted on the first mounting base 210, facilitating the replacement and disassembly of the first protection lens 220.

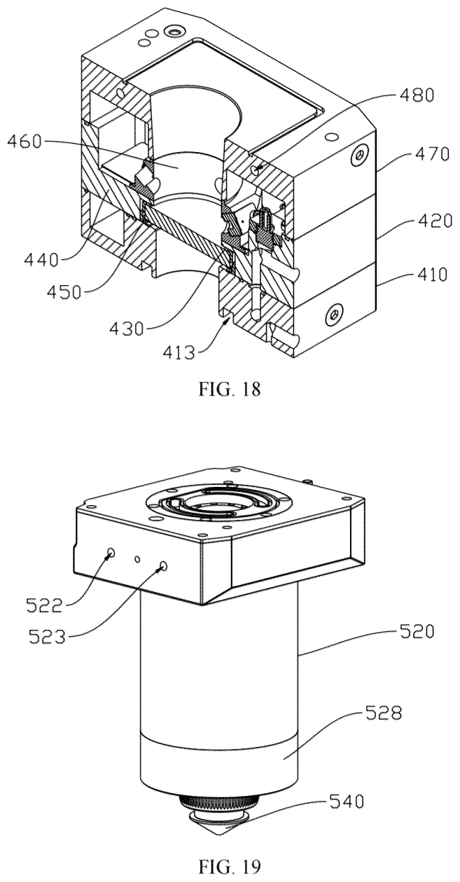

In some embodiments, as shown in FIG. 17 and FIG. 18, the second protection assembly 400 includes a lower mounting base 410, an upper mounting base 420, a second protection lens 430, a second lens holder 440, and a sealing member 450. The lower mounting base 410 is docked with the upper mounting base 420, and the lower mounting base 410 is detachably connected to the upper mounting base 420. The second protection lens 430 is mounted on the second lens holder 440. The second lens holder 440 is fixed between the lower mounting base 410 and the upper mounting base 420. The sealing member 450 is located between the second protection lens 430 and the lower mounting base 410. The second protection lens 430 is hermetically connected to the lower mounting base 410 through the sealing member 450. The second protection assembly 400 is modularized, so that the installation and disassembly of the second protection assembly 400 is facilitated and it is convenience for users to operate.

It is understandable that the gas outlet ports of the second gas channels 562 face towards the second protection assembly 400, and the gas discharged from the second gas channels 562 is ejected towards the second protection assembly 400. The second protection assembly 400 is designed as a sealed structure, so that the gas hits the second protection lens 430 and diverts, and flows into the second light transmitting and gas blowing channel 561 below, achieving pressure equalization.

Based on the aforementioned embodiments, the sealing member 450 is a spring energized seal (Variseal), which is located within the second lens holder 440. One side of the spring energized seal fits the second protection lens 430, and another side fits a top of the lower mounting base 410.

It is understandable that the gas outlet ports of the second gas channels 562 blow gas towards the second protection assembly 400. Upon being inflated, two sides of the spring energized seal tightly fits the second protection lens 430 and the lower mounting base 410, resulting in a high gas pressure and good sealing effect.

Based on the aforementioned embodiments, as shown in FIG. 18, a monitoring installation plate 460 is arranged in the upper mounting base 420. A temperature sensor, a pressure sensor, and a light sensor are arranged on the monitoring installation plate 460.

Based on the aforementioned embodiments, as shown in FIG. 17 and FIG. 18, a first gas inlet port 411 and a second gas inlet port 412 are arranged on the lower mounting base 410. A second communication groove 413 is formed at a side, facing towards the gas blowing cover plate 570, of the lower mounting base 410. The second communication groove 413 corresponds to the first communication groove 571. The first gas inlet port 411 is in communication with the second communication groove 413, and the second communication groove 413 is in communication with the first communication groove 571, so that the first gas inlet port 411 is in communication with the first light transmitting and gas blowing channel 511, and the second gas inlet port 412 is in communication with the cooling gas channel 521.

As a variation, the first gas inlet port 411 and the second gas inlet port 412 can be directly arranged on the laser cutting nozzle 500, as long as gas intake is achieved.

In some embodiments, as shown in FIG. 17 and FIG. 18, the second protection assembly 400 further includes a second adapter block 470. The second adapter block 470 is arranged on a side, facing away from the lower mounting base 410, of the upper mounting base 420. The optical module 300 is connected to the lower mounting base 410 through the second adapter block 470. Multiple second adapter blocks 470 can be arranged depending on focusing distance of the focusing assembly 320. A fifth heat dissipation channel 480 is formed on the second adapter block 470. The fifth heat dissipation channel 480 cools the focusing assembly 320 and improves the heat dissipation effect of the optical module 300.

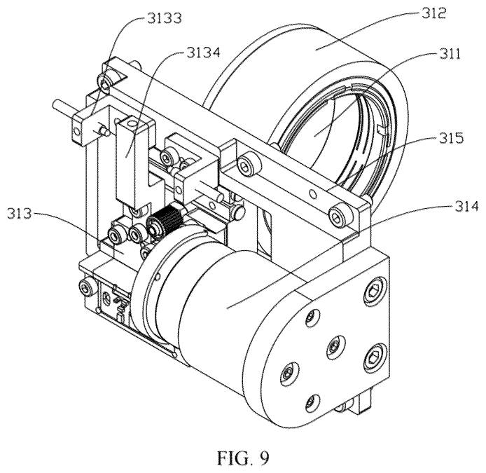

Based on the aforementioned embodiments, as shown in FIG. 9, the collimation assembly 310 includes a collimation lens 311, a collimation lens holder 312, a sliding mechanism 313, and a driving mechanism 314. The collimation lens 311 is mounted inside the collimation lens holder 312. The sliding mechanism 313 can be selected as a standard guide rail module to reduce installation difficulty, improve structural stability, precision, and load-bearing capacity, and enhance the maintainability, interchangeability, and stability of the structure of the collimation assembly 310. The sliding mechanism 313 includes a guide rail 3131 and a sliding block 3132. The collimation lens holder 312 is fixedly connected to the sliding block 3132, and the driving mechanism 314 is connected to the sliding block 3132. The driving mechanism 314 drives the sliding block 3132 to move, and the sliding block 3132 drives the collimation lens holder 312 to move towards or away from the first protection assembly 200, realizing automatic adjustment of the collimation lens 311. This automatic adjustment is high in precision and simple in adjustment operation.

The collimation assembly 310 is designed as a module which is served as a separate functional module within the entire cutting head. The collimation assembly 310 is easy to assemble and disassemble, and high in reliability and maintainability. The module and the cutting head housing are designed as quick-release structures, facilitating the maintenance and replacement of the collicooperation lens.

Based on the aforementioned embodiments, as shown in FIG. 9, the sliding mechanism 313 further includes two limiting pieces 3133 and a limiting cooperation piece 3134. The limiting pieces 3133 are stopping columns, and the limiting cooperation piece 3134 is a stopping plate. The limiting cooperation piece 3134 is arranged on the sliding block 3132, and the two limiting pieces 3133 are arranged at intervals. The limiting cooperation piece 3134 is arranged between the two limiting pieces 3133. In case that the driving mechanism 314 drives the sliding block 3132 to move, it also drives the limiting cooperation piece 3134 to move until the limiting cooperation piece 3134 abuts against the limiting pieces 3133, and the collimation lens 311 has reached its limit position.

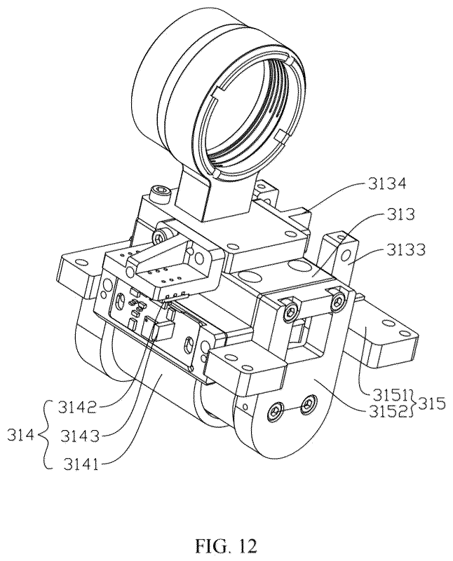

In some embodiments, as shown in FIG. 9 and FIG. 12, the collimation assembly 310 further includes a fixing bracket 315 arranged on the second housing 330, and a driving mechanism 314 is arranged on the fixing bracket 315.

In some embodiments, as shown in FIG. 12, the driving mechanism 314 includes a voice coil motor 3141 connected to the sliding mechanism 313. The voice coil motor 3141 is configured to drive the collimation lens holder 312 to move towards or away from the first protection assembly 200. The voice coil motor 3141 has the advantages of large torque, strong load-bearing capacity, and high acceleration, and it can control the collimation lens 311 to quickly complete adjustment actions, which has the advantages of short zoom time, small size, and compact structure.

In some embodiments, as shown in FIG. 12, the driving mechanism 314 further includes a magnetic scale 3142 and a sensing element 3143. The sensing element 3143 is connected to the voice coil motor 3141 through a signal and is arranged opposite to the magnetic scale 3142. The sensing element 3143 is fixedly arranged, while the magnetic scale 3142 is connected to the collimation lens holder 312, allowing relative movement between the sensing element 3143 and the magnetic scale 3142.

It is understandable that through the cooperation between the magnetic scale 3142 and the sensing element 3143, a movement distance of the collimation lens 311 can be accurately calculated. The operation of the voice coil motor 3141 is controlled through an external circuit, precise adjustment of the collimation lens 311 can be achieved.

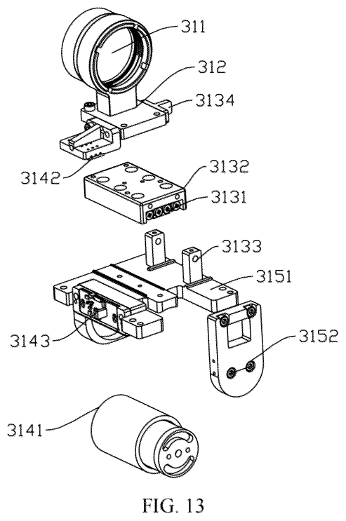

As shown in FIG. 12 and FIG. 13, the fixing bracket 315 includes a motor fixing plate 3151 and a coil fixing plate 3152. The motor fixing plate 3151 is fixedly connected to the second housing 330, and the voice coil motor 3141 is fixed to one side of the motor fixing plate 3151. The sliding mechanism 313 is disposed on the other side of the motor fixing plate 3151. The coil fixing plate 3152 is fixed to an end of a coil of the voice coil motor 3141, and is fixedly connected to the sliding block 3132. The limiting pieces 3133 are arranged on the motor fixing plate 3151. The collimation assembly 310 and the second housing 330 are of quick-release modular structures, facilitating the maintenance of the collimation lens 311. In case that the collimation lens 311 is damaged, only the collimation assembly 310 needs to be removed as a whole, improving maintainability of the product. Meanwhile, the collimation lens 311 and the collimation lens holder 312 are both of standardized modular structures. In case that the collimation lens 311 is maintained, only the standardized module needs to be replaced, simplifying installation and maintenance.

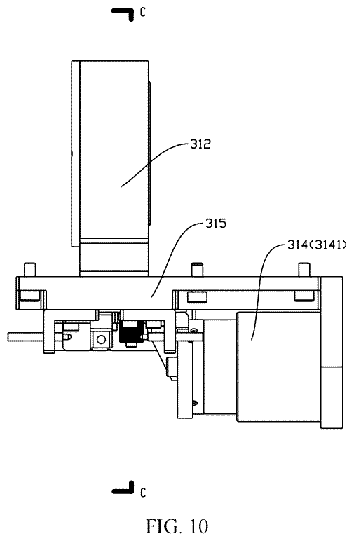

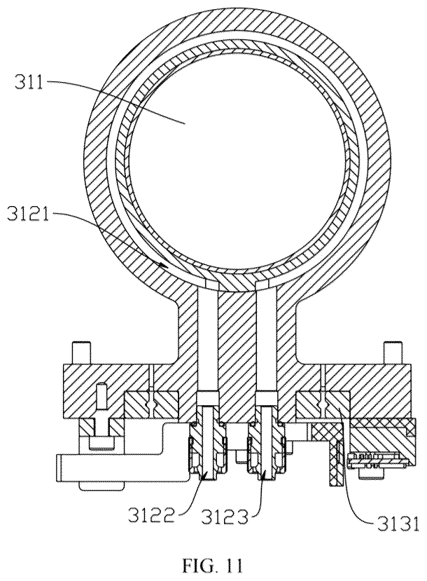

In some embodiments, as shown in FIG. 10 and FIG. 11, a third heat dissipation channel 3121, a third inlet port 3122, and a third outlet port 3123 are arranged in the collimation lens 312. The third inlet port 3122 and the third outlet port 3123 are in communication with the third heat dissipation channel 3121.

It is understandable that in the embodiments of the present application, the third heat dissipation channel 3121 is individually arranged in the collimation lens holder 312 to directly dissipate heat from the collimation lens 311, so that the situation where the collimation lens 311 is burnt out is avoided, and the safety and reliability of the collimation lens 311 is ensured, and makes it more suitable for high-power laser cutting applications.

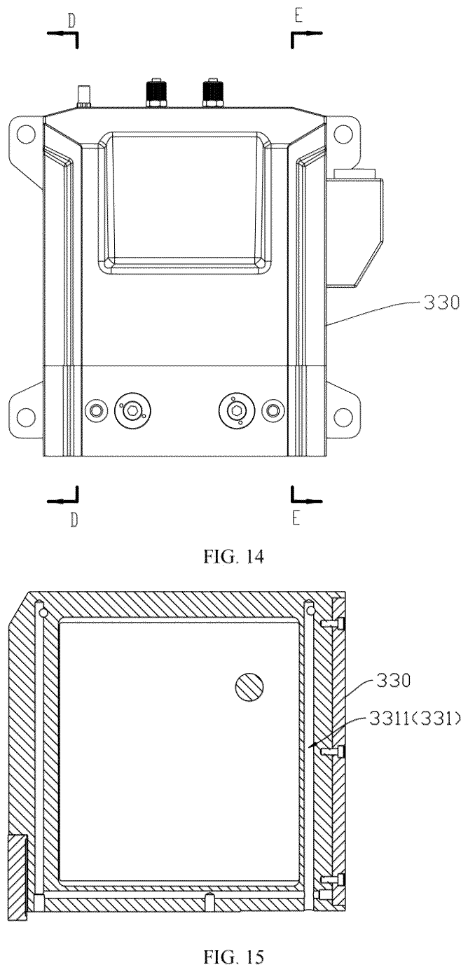

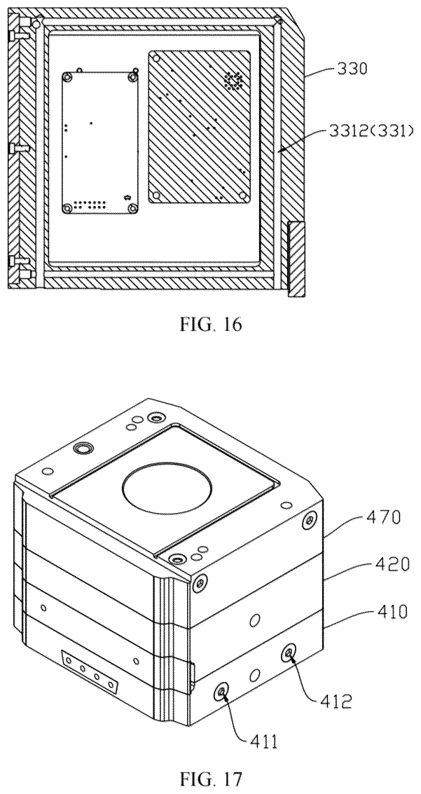

In some embodiments, as shown in FIG. 14, FIG. 15, and FIG. 16, a fourth heat dissipation channel 331 is formed on the second housing 330. The fourth heat dissipation channel 331 is in communication with the fifth heat dissipation channel 480. The fourth heat dissipation channel 331 flows through the side and top surfaces of the second housing 330.

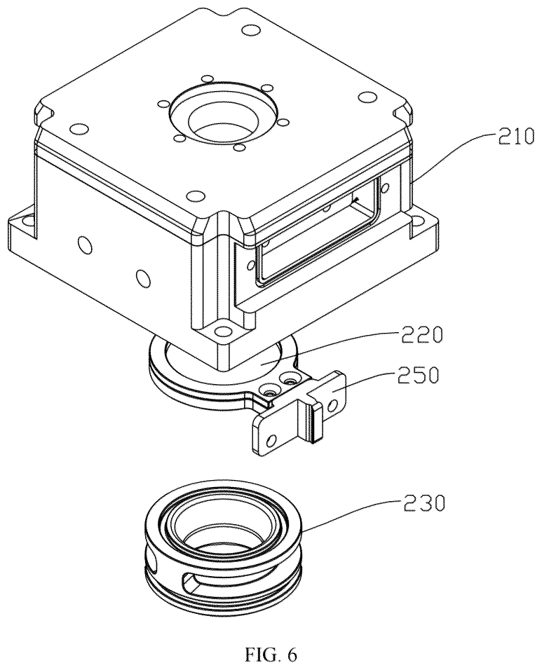

As shown in FIG. 15, FIG. 16, FIG. 5, and FIG. 2, the fourth heat dissipation channel 331 includes a water inlet channel 3311, a water outlet channel 3312, and a fourth inlet port 3313. The fourth inlet port 3313 is arranged on the first mounting base 210. The water inlet channel 3311 is arranged on one side of the second housing 330, and the water outlet channel 3312 is arranged on the other side of the second housing 330, with the two sides arranged opposite to each other. The water inlet channel 3311 and the water outlet channel 3312 are in communication with the fifth heat dissipation channel 480. The water outlet channel 3312 shares the second outlet port 242 with the second heat dissipation channel 240, achieving integration of pipelines and reducing openings.

In the above-mentioned embodiments, the descriptions of each embodiment have their respective emphases. Parts not detailed in one embodiment can be referred to the relevant descriptions of other embodiments.

In the description of the present application, the terms “first” and “second” are used for descriptive purposes only and are not intended to indicate or imply relative importance or implicitly specify the number of technical features indicated. Thus, features labeled “first” and “second” may include one or more features.

The laser cutting nozzle according to the embodiments of the present application has been described in detail above. In the present application, specific examples are used to illustrate the principles and implementations of the present application. The descriptions of the above embodiments are only used to help understand the methods and core ideas of the present application. At the same time, for persons skilled in the art, based on the ideas of the present application, there will be changes made on specific embodiments and application scopes. Therefore, the content of this specification should not be construed as limiting the present application.

1. A laser cutting nozzle, comprising:
a first sleeve, a first light transmitting and gas blowing channel being formed inside the first sleeve, a first gas channel being formed on the first sleeve, and the first gas channel extending along an axial direction of the first sleeve;
a first housing sleeved on the first sleeve;
a nozzle connected to the first housing, the first light transmitting and gas blowing channel being in communication with the nozzle; and
a flow equalization block arranged within the first sleeve, a second light transmitting and gas blowing channel being formed inside the flow equalization block, and the second light transmitting and gas blowing channel being in communication with the first light transmitting and gas blowing channel; a plurality of second gas channels being formed between the flow equalization block and the first sleeve, and the second gas channels extending along the axial direction of the first sleeve and being arranged at intervals along a circumferential direction of the flow equalization block; a gas inlet port of the first gas channel facing away from the nozzle, and gas outlet ports of the second gas channels facing away from the nozzle; the first gas channel being in communication with the second gas channels, and the second gas channels being in communication with the second light transmitting and gas blowing channel.

2. The laser cutting nozzle according to claim 1, wherein a first heat dissipation channel is formed between the first housing and the first sleeve; a cooling gas channel, a first inlet port, a first outlet port, and a first gas outlet port are formed on the first housing; the first inlet port and the first outlet port are in communication with the first heat dissipation channel, the first gas outlet port is in communication with the cooling gas channel, and the first gas outlet port is located on a side, close to the nozzle, of the first housing.

3. The laser cutting nozzle according to claim 2, wherein fins are spirally arranged on an outer surface of the first sleeve, and the fins are hermetically connected to the first housing to form the first heat dissipation channel.

4. The laser cutting nozzle according to claim 2, wherein the first housing comprises:
a cone sleeved on the first sleeve, the first heat dissipation channel being formed between the cone and the first sleeve; and
a ceramic ring arranged on a side, close to the nozzle, of the cone, the ceramic ring being connected to the nozzle; the cooling gas channel being arranged to penetrate through the cone and the ceramic ring, and the first gas outlet port being arranged on a side, close to the nozzle, of the ceramic ring.

5. The laser cutting nozzle according to claim 4, wherein the first housing further comprises a first adapter block arranged between the cone and the ceramic ring; the cone is connected to the ceramic ring through the first adapter block, and the cooling gas channel is arranged to penetrate through the cone, the adapter block, and the ceramic ring.

6. The laser cutting nozzle according to claim 1, wherein the plurality of second gas channels are arranged at same intervals along a circumferential direction of the flow equalization block.

7. The laser cutting nozzle according to claim 1, wherein the gas outlet ports of the second gas channels are arranged close to the nozzle.

8. The laser cutting nozzle according to claim 1, wherein a plurality of first grooves and a plurality of second grooves are arranged on an outer surface of the flow equalization block; the first grooves extend along an axial direction of the flow equalization block, the second grooves extend along the circumferential direction of the flow equalization block, and the second grooves are arranged on a side, close to the nozzle, of the flow equalization block; the first grooves are in communication with the second grooves, and the first gas channel is in communication with the second grooves; the flow equalization block is hermetically connected to the first sleeve, and the first grooves and the second grooves are blocked through an inner wall of the first sleeve to form the second gas channels.

9. The laser cutting nozzle according to claim 1, further comprising:
a gas blowing cover plate arranged inside the first sleeve and located on a side, facing away from the nozzle, of the flow equalization block; a first communication groove is arranged on a side, facing away from the flow equalization block, of the gas blowing cover plate, and the first communication groove are in communication with the gas inlet port of the first gas channel.

10. The laser cutting nozzle according to claim 1, further comprising a second protection assembly, and the second protection assembly comprising a lower mounting base, an upper mounting base, a second protection lens, a second lens holder, and a sealing member; the lower mounting base being docked with the upper mounting base, the second protection lens being mounted on the second lens holder, the second lens holder being fixed between the lower mounting base and the upper mounting base, the sealing member being located between the second protection lens and the lower mounting base, and the second protection lens being hermetically connected to the lower mounting base through the sealing member.

11. The laser cutting nozzle according to claim 10, wherein the sealing member is a spring energized seal, the spring energized seal is located inside the second lens holder, one side of the spring energized seal fits the second protection lens, and another side of the spring energized seal fits a top of the lower mounting base.

12. The laser cutting nozzle according to claim 10, further comprising:
a gas blowing cover plate arranged inside the first sleeve and located on a side, facing away from the nozzle, of the flow equalization block; a first communication groove is arranged on a side, facing away from the flow equalization block, of the gas blowing cover plate, and the first communication groove is in communication with the gas inlet port of the first gas channel.

13. The laser cutting nozzle according to claim 12, wherein a first gas inlet port and a second gas inlet port are formed on the lower mounting base; a second communication groove is arranged on a side, facing towards the gas blowing cover plate, of the lower mounting base; the lower mounting base is hermetically connected to the gas blowing cover plate; the second communication groove corresponds to the first communication groove, the first gas inlet port is in communication with the second communication groove, the second communication groove is in communication with the first communication groove; and the second gas inlet port is in communication with a cooling gas channel.

14. The laser cutting nozzle according to claim 13, wherein the flow equalization block is in a shape of a cylinder and arranged inside the first sleeve; a mounting hole is arranged inside the first sleeve, and the mounting hole is adapted to the flow equalization block.

15. The laser cutting nozzle according to claim 14, wherein the gas blowing cover plate is connected to a side, facing away from the nozzle, of the first sleeve to fix the flow equalization block inside the mounting hole.
